(19) United States
(12) Patent Application Publication
(10) Pub. No.: US 2019/0150490 A1
(43) Pub. Date: May 23, 2019

(54) SYSTEM AND METHOD FOR PREPARING READY-TO-EAT PLANT BASED FOODS

(71) Applicant: Michael Mitchell, Boca Raton, FL (US)

(72) Inventor: Michael Mitchell, Boca Raton, FL (US)

(21) Appl. No.: 15/818,419

(22) Filed: Nov. 20, 2017

(51) Int. Cl. A23L 19/00; A23L 5/43; A23J 1/00; A23P 30/00

(52) U.S. Cl. CPC A23L 19/01; A23L 5/43; A23V 2002/00; A23P 30/00; A23J 1/006

(57) ABSTRACT

Embodiments described herein provide a shelf-stable plant-based foodstuff composition having organic chickpea flour, salt, organic beet flour and flavoring agents. Each ingredient of the composition, when mixed with a leavening agent act as a meat substitute, such as a substitute for ground beef which may be used in a variety of recipes.

### FIELD

The present invention generally relates to a formula for a ground meat substitute and a method of food preparation therefrom.

### BACKGROUND

In recent years, the popularity of vegan diets as well as awareness surrounding animal cruelty in the traditional american diet have increased tremendously. Animal meat and protein derived therefrom is generally more expensive and less abundant than vegetable protein causing many to alter their diets for both ethical and health reasons. Meat substitutes are well known in the arts and typically consist of soy or gluten based compositions. For example, tofu, a soy product, has been used in culinary arts for over a thousand years with records dating back to the Han Dynasty in China.

A primary goal of meat substitutes is to mimic texture, flavor, and the aesthetics of the meat it is intended to replace. Typical compositions include soy protein isolates, soybean flour, and gluten as a foundation. Lipids are typically added in order to increase the palatability, while contributing little to the texture of the final product. Additives are also present and may include flavoring compounds, leavening agents, coloring agents, and emulsifiers to achieve the aforementioned similarities to meat products.

Many available meat substitutes currently available share the disadvantage of having a rapid time to spoilage, resulting in an increased amount of food wasted. Further, many available meat substitutes require refrigeration even before the packaging is opened taking up valuable space in a refrigeration unit both in the home and in the commercial setting.

U.S. Pat. No. 5,300,312 to Texas A&M University discloses a method for producing a ready-to-eat intermediate-moisture texturized protein foodstuff which simulates meant and has an extended shelf life. The shelf-stability is achieved through control of free water content and activity in the product.

U.S Pat. No. 6,824,806 to Green Live Vegetable Meat S.R.L discloses a process for producing a vegetable food having a mixture consisting of 45 to 99.9% by weight of gluten an 0.1 to 55% by weight of a flour selected from the group consisting of cereal flours, legume flours, and mixtures thereof, and admixing the flour with water or vegetable broth while kneading until a dough is obtained.

U.S. Pat. No. 4,153,738, U.S. Pat. No. 4,910,038, U.S. Pub. No. 2012/0082762 and U.S. Pat. No. 6,824,806 each disclose production processes for shelf-stable foodstuffs, however, each uses a meat protein rather than a protein sources from plant protein.

It can be seen that an improvement in the arts is needed surrounding ready-to-eat plant based foods. One such solution is described herein.

### SUMMARY OF THE INVENTION

Embodiments described herein provide for a shelf-stable plant-based composition to be used as a meat substitute in a variety of recipes. The plant-based composition has intermediate moisture content to inhibit the growth of microorganisms, allowing the composition to be stored at room temperature in a sealed container for an extended period of time. The plant-based composition has a mixture of a first plant-derived flour, a salt, a coloring agent, and a plurality of flavoring agents. When mixed with a leavening agent, such as water, the composition mimics aesthetics of ground beef in flavor, appearance, and taste profiles. A user may substitute the plant-based composition in any recipe to mimic the flavors of the meat it intends to substitute.

In embodiments, the first plant derived flour is organic chickpea flour that is finely ground to promote adequate mixing and leavening of the final product. Pink himalayan salt may be utilized as the salt to promote a proper flavor profile as well as aid in preservation. The coloring agent may be embodied as organic beet flour which may also be finely ground and contribute to the nutritional profile of the composition. Any number of spices including garlic, onion, and parsley may be utilized to further enhance the flavor profile.

In embodiments, the plant-based composition has a nutritional profile having 0-10% by-weight of fats, 0-20% by-weight of dietary fibers, 0-30% by-weight of sugars, and 10-50% by-weight of protein.

Other aspects, advantages, and novel features of the embodiments will become apparent from the following detailed description in conjunction with the tables.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 is a flowchart of a method of production for a plant-based foodstuff, according to an embodiment of the present invention.

### DETAILED DESCRIPTION

The specific details of the single embodiment or variety of embodiments described herein are set forth in this application. Any specific details of the embodiments are used for demonstration purposes only and no unnecessary limitation or inferences are to be understood therefrom.

In general, the invention disclosed herein relates to a ready-to-eat plant-based foodstuff that is substantially shelf-stable. It is a goal of the present invention to eliminate the use of animal protein in the composition while maintaining familiar aesthetic qualities of the commonly used animal-derived products. Aesthetic qualities include taste, texture, and appearance while maintaining a high protein nutrient profile in the final product.

In a preferred embodiment, the protein may be derived from a plant source such as sprouted chickpea powder. Any method known in the arts, including single or dual stage extrusion machines, may be used to extrude vegetable protein from the chickpea for use in the composition. In further embodiments, a fiber spinner may be utilized as commonly known however this method is substantially more complex.

Sprouting permits easier digestion and increases the bioavailability of the plant-based protein. Dried grains are germinated releasing enzymes stored within the seed. Enzyme activation breaks down complex nutrients into more simple, easy to digest components.

In alternate embodiments, any seed commonly utilized in the culinary arts may be used in the composition to result in a desired nutrient profile, texture, color, or flavor profile. Preferentially, a seed having high alkalinity is used to help regulate the body's pH post-consumption. In a specific example, black bean sprouts are utilized to alter the color to a darker aesthetic profile. The embodiment wherein black beans are utilized may be leavened and baked into a vegan baked-good.

In a preferred embodiment, a sufficient portion of organic or inorganic beet flour is added to the composition. Beet root, and the powder thereof is utilized in the present embodiment as a coloring agent to mimic the natural color of ground beef or similar meat product. One skilled in the arts may appreciate that alternative coloring agents may be used.

To achieve a meat-like flavor profile, a variety of adjuncts and seasoning may be added. Adjuncts may include seasoning including, but not limited to garlic, onion, parsley, salts and other spices, whether organic or inorganic such that the final product is a meat-flavored plant-based product. Flavoring adjuncts are commonly used in the arts to modify and/or mimic common flavors. The composition of the present invention may include a variety of these flavoring adjuncts which may be modified for the intended use of the plant-based composition in a recipe. Flavorings may include natural flavoring substances as well as artificial flavoring substances. Preferentially, natural flavors are derived from non-animal sources, as the goal of the invention is to support a vegan diet. Examples of useful flavorings may include, but is not limited to flavored extracts, volatile oils, essential oils, oleoresin, essence, distillates, and further expulsion of flavor compounds from natural sources such as spices.

While the preferred embodiment of the present invention does not contain dedicated preservatives, one skilled in the art may appreciate that antimicrobial preservatives may be utilized to extend the shelf life of the plant-based composition. Oxygen absorbers may also be utilized to inhibit oxidation. Preferentially, natural foodstuff preservatives may be used such as rosemary extract, hops, salt, sugar, vinegar, alcohol, vitamin C and E, as well as ascorbic and citric acids. Other consumable preservatives may be readily identifiable by one skilled in the art when making obvious modifications to the present composition.

In order to enable for a prolonged shelf life, the composition is formulated to have intermediate moisture content to inhibit growth of microorganisms that would otherwise spoil the foodstuff. The preferential embodiment comprising the mixture of sprouted organic chickpea flour, pink himalayan salt, organic beet flour, and spices results in a powder when packaged. The composition is shelf-stable for at least one year, significantly longer than refrigerated, intermediate moisture plant-based meat substitutes currently available.

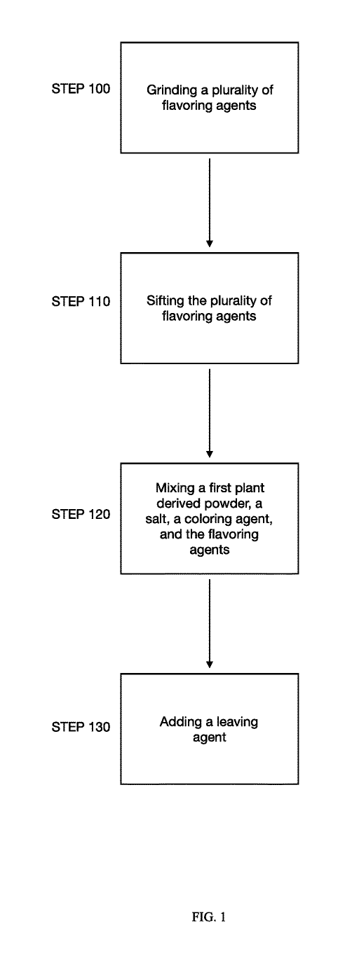

In an embodiment, one or more ingredients undergo the process of super-fine grinding of the powder to enhance the aesthetic characteristics of the final product. Additionally, a step of sifting the super-fine ground flour to ensure the quality of the final product. FIG. 1 illustrates a method of preparation in a preferred embodiment. Step 100 includes grinding a plurality of flavoring agents followed by Step 110 wherein the plurality of flavoring agents are finely sifted. In Step 120, the first plant derived powder is mixed with a salt, a coloring agent, and a the plurality of ground and sifted flavoring agents. In Step 130, a leavening agent is added to prepare the foodstuff for consumption.

In an embodiment, each flavoring agent, including pepper, onion, parsley, and other spices are finely ground to a super-fine specification. Further, the super-finely ground spices are sifted to ensure no clumping or coagulation remains.

Table 1 below illustrates a preferred embodiment of the ingredient composition, including sprouted organic chickpea flour, pink himalayan salt, organic beet flour, and organic spices (including garlic, onion, and parsley).

TABLE 1
Ingredients
Organic Sprouted Chickpea Flour
Sodium
Pink Himalayan Salt
Organic Beet Flour
Organic Spices

In the present embodiment, intermediate moisture may be defined as a substance or composition which has a water activity below that which is required for the growth of microorganisms. In many cases, this is a moisture content between 10-50%, however lower moisture contents are also useful.

Shelf-stable may be defined as a foodstuff that has been processed to be safely stored at room temperature in a sealed container.

In an embodiment, a nutritional profile resulting from the formulation of the plant-based composition has a fat content of 6%, dietary fiber at 8%, sugars at 13%, and protein at 21.7%. Each percent is expressed as a percent-by-weight per serving of the plant-based composition. Iron, Potassium, among other minerals may be present after their extrusion from the plant sources. An exemplary nutritional profile may be seen in the following Table 2.

TABLE 2

| | amount per serving | | % by weight per serving |
|---|---|---|---|
| Fat | 1.5 | g | 6% |
| Sodium | 310 | mg | 1% |
| Dietary Fiber | 2 | g | 8% |
| Sugars | 3 | g | 13% |
| Protein | 5 | g | 21.7% |
| Iron | 1 | mg | <1% |
| Potassium | 187 | mg | <1% |

In alternate embodiment, fat content may range between 0% and 10%, dietary fiber may range between 0% and 20%, sugars may range at 0% to 30%, and protein may range 10% to 50% of the percentage by weight of the plant-based composition.

TABLE 3

| | % by weight per serving |
|---|---|
| Fat | 0-10% |
| Dietary Fiber | 0-20% |
| Sugars | 0-30% |
| Protein | 10-50% |

In a preferred embodiment, the caloric density of the plant-based composition is 260 kcal per 23 gram serving size.

As a powder, the composition is typically leavened prior to use as a component in a meal. Leavening protocols may vary depending on desired texture of the final product, intended use, and specific meat the user wishes to mimic. Typically, the leavening agent is intermixed with the plant-based composition and mixed until substantially homologous. Following leavening, the leavened composition may be prepared following recipe protocol such that the final product has an aesthetic profile near most the meat product it intends to substitute, for example ground beef.

For the composition to be leavened and prepared into a suitable meat substitute, a specific water content must be added and intermixed. The water content may change depending on the intended substitution. Table 4 below illustrates suggested mixing ratios between the present composition and water to achieve a specific result when mixed and heated appropriately. In an example, a ground beef substitute to be used as a beef hamburger substitute requires about 1 cup of the vegan meat substitute composition to be mixed with ⅔ cup of water. A ground beef for tacos or a similar application require about 1 cup composition to ¾ cup water. This ratios is the same as a crumble, however flavor agents or additives may be changed to mimic varying flavors. A meatball substitute may be prepared with 1 cup of vegan composition and ⅓ cup water, while a crumble substitute may be prepared with 1 cup vegan composition and ¼ cup water.

TABLE 4

| Intended Vegan Meat | | |
|---|---|---|
| Substitute | Vegan Composition | Water |
| Ground Beef for Burgers | 1 cup | ⅔ cup |
| Ground Beef for Tacos | 1 cup | ¾ cup |
| Meatball | 1 cup | ⅓ cup |
| Crumble | 1 cup | ¾ cup |

Vegan options are available as leavening and binding agents. In a non-vegan composition, eggs are typically used in order to bind a composition. If the user desires for the composition to remain vegan, options may include tofu, tapioca starch, ground flax seed, and peanut flour among others.

While organic sprouted chickpea flour is preferred in the embodiment to provide optimal bioavailability and digestion, one skilled in the art may appreciate that additional substitutes and extrusions thereof may be used including; seitan, rice, mushrooms, legumes, tempeh, yam flour, almonds, and cashews.

In a preferred embodiment, the plant-based composition is prepared into a foodstuff usable in a variety of recipes by mixing a sufficient amount of the plant-based composition with a sufficient amount of water to leaven the mixture. The leaventated mixture is then heated and served for consumption. Amount of water added may depend on desired viscosity of the final product and meat from which the substitution is intended.

In an alternate embodiment, the leavened mixture may forgo heating to be used as a paste, similar to a hummus. One skilled in the culinary arts may find a variety of used for the plant-based composition.

It will be appreciated by persons skilled in the art that the present embodiment is not limited to what has been particularly shown and described hereinabove. A variety of modifications and variations are possible in light of the above teachings without departing from the following claims.

What is claimed is:

1. A plant-based composition formulated as a foodstuff comprising:
a first plant-derived flour;
a salt;
a coloring agent;
a plurality of flavoring agents;
wherein the first plant-derived flour, the salt, the coloring agent, and the plurality of flavoring agents are mixed to form a plant-based composition having intermediate moisture, and
wherein the plant-based composition is shelf-stable.

2. The foodstuff of claim 1, further comprising a leavening agent.

3. The foodstuff of claim 2, wherein the leavening agent is water.

4. The foodstuff of claim 1 having between 10-50% protein by-weight.

5. The foodstuff of claim 4, wherein the protein is extruded from a plant to form the first plant-derived flour.

6. The foodstuff of claim 5, wherein the first-plant derived powder is finely ground and sifted to aid in aesthetics.

7. The foodstuff of claim 6, wherein the plant-derived flour is sprouted organic chickpea flour.

8. The foodstuff of claim 1 having between 0-10% fats by-weight.

9. The foodstuff of claim 1 having between 0-20% dietary fiber by-weight.

10. The foodstuff of claim 1 having between 0-30% sugars by-weight.

11. The foodstuff of claim 1, wherein the coloring agent is a second plant-derived flour.

12. The foodstuff of claim 11, wherein the second plant-derived flour is organic beet flour to mimic a beef-like color.

13. A method of preparing a plant-based composition into a foodstuff comprising the steps of:
grinding a plurality of flavoring agents;
sifting the plurality of flavoring agents;
mixing a first plant-derived flour, a salt, a coloring agent, and the plurality of flavoring agents to form a shelf-stable plant-based composition having intermediate moisture to produce a shelf-stable plant-based composition.

14. The method of claim 13 further comprising the step of adding a leavening agent to leaven shelf-stable plant-based composition.

15. The method of claim 14, wherein the leavening agent is water.

16. The method of claim 13 having between 10-50% protein by-weight.

17. The method of claim 13, wherein the first plant-derived flour is sprouted organic chickpea flour.

18. The method of claim 13 having between 0-10% fats by-weight, having between 0-20% dietary fiber by-weight, and having between 0-30% sugars by-weight.

19. The method of claim 13, wherein the coloring agent is a second plant-derived flour.

20. The method of claim 19, wherein the second plant-derived flour is organic beet flour to mimic a beef-like aesthetic.
